(19) United States
(12) Patent Application Publication
(10) Pub. No.: US 2017/0056883 A1
(43) Pub. Date: Mar. 2, 2017

(54) IN SITU CONTROL OF FLUID MENISCI

(71) Applicants: OXFORD UNIVERSITY INNOVATION LIMITED, Oxford (GB); UNIVERSIDAD CARLOS III DE MADRID, Leganes, Madrid (ES)

(72) Inventors: Dirk Aarts, Oxford (GB); Andrew Parry, London Greater London (GB); Carlos Rascón Diaz, Madrid (ES)

(21) Appl. No.: 15/118,661

(22) PCT Filed: Feb. 10, 2015
(86) PCT No.: PCT/GB2015/050358

§ 371 Date: Aug. 12, 2016

(30) Foreign Application Priority Data
Feb. 14, 2014 (GB) 1402654.6

(51) Int. Cl. B01L 3/00

(52) U.S. Cl. CPC B01L 3/502746; B01L 3/50273; B01L 2300/16; B01L 2300/0838; B01L 2400/0457; B01L 2300/123; B01L 2300/18; B01L 2400/082

(57) ABSTRACT

A system includes a non-vertical channel containing a fluid forming a fluid meniscus having a capillary length and a contact angle θ. The channel in cross-section has a perimeter length |Σ| and an area |Ω|. The cross-section of the non-vertical channel is selected so as to define a constant Lagrange multiplier λ, where λ=|Σ|cos θ/|Ω|. A functional Φ[Γ*]Ξ|Γ*|−cos θ|Σ*|+(1/a²)G*+λ|Ω*| is minimised to define a minimum value Φ₀=MinΦ. At a critical transition where Φ=0, the fluid defines a smooth arc of length [Γ*] that divides the cross-section of the channel into two parts. |Ω*| is the cross-sectional area of the fluid, which has a curve of length |Σ*| in contact with the channel, and G* represents a vertical position of the centre of mass of the fluid multiplied by the cross-sectional area |Ω*|. How far the fluid meniscus extends along the channel is controlled by one or more parameters of the functional Φ[Γ*].

This invention relates to the control of fluid menisci from mesoscopic to nanoscopic scales, for example for use in micro- to nano-fluidics devices.

The interface between a liquid and a gas (or between two coexisting fluids) in a capillary is called the meniscus. The shape and position of the meniscus depends on:
1. The capillary length a
2. The contact angle θ
3. The orientation of the capillary
4. The cross-sectional shape and size of the capillary

The capillary length is a physical magnitude that does not refer to any property of the capillary itself (in particular, to the geometrical length of the capillary), but rather refers to the liquid and gas contained in it, and the interface (or meniscus) between them. The capillary length is defined as

$$a = \sqrt{\frac{σ}{g Δ ρ}}$$

where σ is the liquid-gas (or fluid-fluid) surface tension, g is the local gravitational acceleration, and Δρ is the density difference between the liquid and the gas (or the two fluids).

In turn, the contact angle θ refers to the angle formed by the meniscus with the walls of the capillary, and is defined as σ cos θ=σ_{wg}−σ_{wl}, in terms of the wall-gas and wall-liquid surface tensions σ_{wg} and σ_{wl}, respectively.

When a capillary filled with liquid is turned to the horizontal, one of two things can happen: either the liquid spills (as water from a tipped glass) or it remains trapped in the capillary (as in a drinking straw). Roughly speaking, if the capillary width is substantially larger than a, the liquid spills, while if it much less than a, it remains trapped. If we consider horizontal capillaries with a given cross-sectional shape but variable cross-sectional size L (for example, a circle of variable radius L, or a square of variable side length L), there exists a critical value of this size L_{E} that separates the two regimes. Above this critical size (L>L_{E}), the meniscus is infinitely long which, in practical terms, means that it has reached the end of the capillary and has spilled out. We say that these menisci are in an unbound state. Below this critical size (L<L_{E}), that is, when the liquid is held in the capillary, we say that the meniscus is in a bound state. In this state, the meniscus is always finite in length, but still can be arbitrarily long depending on the value of the actual cross-sectional size of the capillary L. In fact, the closer L is to the critical value L_{E}, the longer the meniscus is. In addition, the closer L is to this critical value, the more sensitive the meniscus shape is to any change in parameters: it enters a critical state. This phenomenon has recently been discussed in detail for the particular case of a horizontal slit capillary; see, Parry et al. (Phys. Rev. Lett. 108, 246101 (2012)).

Previous studies of a liquid trapped in a non-vertical capillary have only considered the critical emptying transition at sizes greater than the capillary length. It is an object of the present invention to exploit the meniscus in a non-vertical capillary in new ways.

When viewed from a first aspect, the present invention provides a method of controlling a fluid meniscus in a non-vertical channel, comprising:
containing a fluid in a non-vertical channel so as to form a fluid meniscus having a capillary length a and a contact angle θ, the channel in cross-section having a perimeter length |Σ| and an area |Ω|;
selecting the cross-section of the non-vertical channel so as to define a constant Lagrange multiplier λ, where

$$λ = \frac{\vert Σ \vert cos θ}{\vert Ω \vert} ;$$

minimising a functional

$$Φ [ {Γ}^{*} ] ≡ \vert {Γ}^{*} \vert - cos θ \vert {Σ}^{*} \vert + \frac{1}{{a}^{2}} {G}^{*} + λ \vert {Ω}^{*} \vert$$

to define a minimum value Φ₀=MinΦ, wherein, at a critical transition where Φ₀=0, the fluid defines a smooth arc of length |Γ*| that divides the cross-section of the channel into two parts, |Ω*| is the cross-sectional area of the fluid, which has a curve of length |Σ*| in contact with the channel, and G* represents a vertical position of the centre of mass of the fluid multiplied by the cross-sectional area |Ω*|; and
controlling how far the fluid meniscus extends along the channel by selecting one or more parameters of the functional Φ[Γ*].

The functional Φ[Γ*] can be related to a fluid “tongue” extending along the non-vertical channel with a controllable meniscus. At the critical transition where the minimum Φ₀=0, the tongue of fluid becomes infinitely long. Accordingly, for Φ₀≦0 the fluid will empty from the channel regardless of the channel length. But in the regime where Φ₀>0 it is possible to control the length of the fluid tongue relative to the channel and hence determine whether emptying occurs or not. This can be controlled through the interrelated variables Γ*, Σ* and Ω*, the Lagrange multiplier λ, and the capillary length a.

Thus it can be appreciated by a person skilled in the art that how far the fluid meniscus extends along the channel can be varied by changing the functional parameters listed above, for example in order to change the interfacial area of the meniscus. The extension of the fluid meniscus along the channel can be sensitive to small changes in parameters, particularly when close to critical emptying of the channel. The change in the meniscus can be a reversible change while it is in a bound state, for example increasing the interfacial area of the meniscus in order to carry out a chemical reaction, or it can be an irreversible change, causing the fluid bound by the meniscus to unbind and drain from the channel.

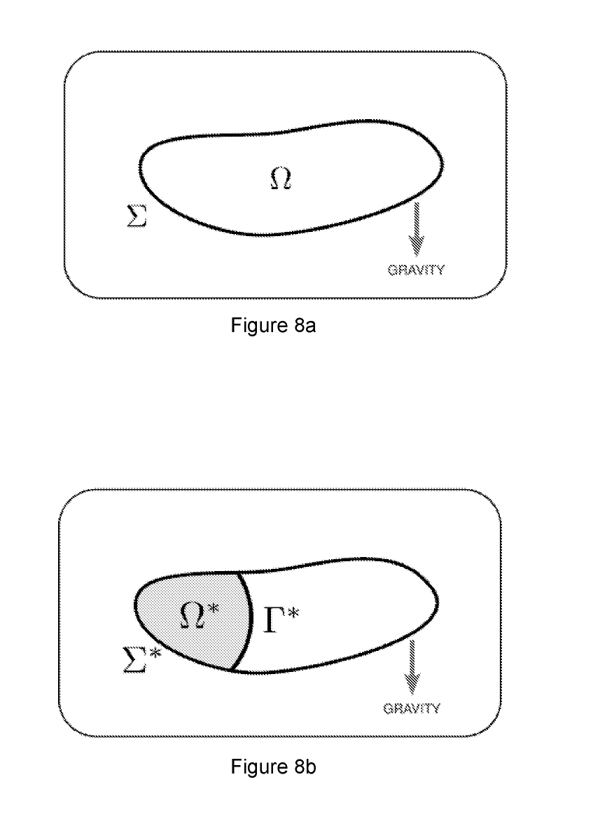

Each of the parameters in the above functional have some dependence on Γ*, the arc length of the meniscus (see FIG. 8b), as they are all related to how far the fluid meniscus extends along the channel. This dependence is shown in the functional Φ[Γ*], where any parameter which is starred is dependent on Γ*. Due to this dependence, most of the parameters cannot be changed independently, as each of the starred parameters will affect one another.

What is meant by a non-vertical channel is one in which there is a horizontal component, i.e. the elongate axis of the channel is between 0 and 89° to the horizontal.

The method may further comprise selectively emptying the fluid from the non-vertical channel by controlling one or more parameters so that Φ₀≦0. At the critical emptying boundary where Φ₀=0, the arc Γ* happens to be the section of the infinitely long fluid meniscus extending along the capillary. This is possible even when the channel has a diameter smaller than the capillary length a of the fluid. Previously, draining has only been possible above the capillary length a, but by controlling one or more parameters such as the cross-section of the channel, it is possible to force draining in much smaller channels. This is beneficial as it allows increased control over micro- and nano-fluidics devices.

The method can also be used to control how far the fluid meniscus extends along the channel without emptying. The extension of the fluid meniscus can have important consequences for the behaviour of fluids; for example, controlling the extension of a meniscus formed between two different fluids can allow a user to control interfacial processes, such as the rate of a chemical reaction or catalysis carried out at the meniscus.

The cross-section of the channel may be chosen based on a number of factors, such as size, shape and/or orientation. However, size may be kept constant while other parameters are varied, and In a set of embodiments, selecting the cross-section of the channel comprises varying the shape and/or orientation of the channel. This allows the cross-section to be varied while remaining with an effective diameter below the capillary length. The cross-section can therefore be used to induce draining in channels which have a diameter smaller than the capillary length of the meniscus formed between the fluids.

In a set of embodiments, selecting one or more parameters of the functional Φ[Γ*] comprises selecting or changing one of more fluid parameters. The parameters of the fluid(s) which can be changed may either be absolute or relative parameters. For example, a material parameter such as the capillary length a is absolute, whereas the relationship between the diameter of the channel and the capillary length a of a fluid is a relative parameter that can be modified by changing an absolute parameter of the fluid(s) and/or of the channel. A parameter of the fluid(s) may be changed directly or indirectly. In a set of embodiments, the fluid parameters which can be changed are the contact angle θ between the meniscus and the channel, and the capillary length a.

In one example, the contact angle θ is preferably changed by adjusting a material parameter of the fluid, for example by adjusting the density, chemical composition or hydrophobicity of one of the fluids. Alternatively, or in addition, the contact angle θ can be changed by adding a surfactant to the fluid.

In another example, alternatively or in addition, the contact angle θ may be changed by adjusting a material parameter of the channel. This preferably comprises modifying the wetting properties of at least a region of the channel surface, for example by applying an electric field. This is known as electrowetting, and allows for the surface tension of the fluids contacting the surfaces to be altered in a highly controllable manner.

In addition, or alternatively, in a set of embodiments controlling how far the fluid meniscus extends along the channel comprises changing the capillary length a by altering the fluid. In one example, changing the capillary length a comprises adjusting the temperature of the fluid(s). This can allow the properties of both fluids to be changed at the same time. Alternatively, or in addition, changing the capillary length a may comprise adjusting the density of the fluid(s), for example when sugar is dissolved in water in order to increase the density. Changing the density can allow the capillary length a to be changed without necessarily changing properties of both of the fluids involved. Another method of changing the capillary length a comprises adjusting the composition of the fluid(s), for example by adding a surfactant to one or more of the fluids. This lowers the surface tension of one or more of the fluids, reducing the capillary length.

In addition, or alternatively, in a set of embodiments controlling how far the fluid meniscus extends along the channel comprises changing the gravitational acceleration. This impacts upon both the fluids and the channel, and alters the capillary length of the meniscus formed between the two fluids in accordance with the equation above. This could be of use, among other things, to measure the strength of microgravitational fields.

In addition or alternatively to the above, indirect methods of changing one or more fluid parameters may include changing the cross-section of the channel, for example using external pressure or piezoelectricity to cause a change of shape and/or dimensions. This may involve changing a local radius of curvature in the channel, which affects how the meniscus forms, as a meniscus will preferentially form over regions of high curvature as this is the most energetically stable position. However, filling conditions might dictate that the meniscus forms elsewhere in the channel. Changing the cross-section of the channel will alter characteristics of the meniscus, for example the length, area or asymmetry of the meniscus formed.

In addition, or alternatively, in a set of embodiments the parameters of the functional Φ[Γ*] can be changed by changing the rotational orientation of the channel in a horizontal plane. This will impact on the meniscus if the channel is not rotationally invariant, for example in an elliptical channel. By rotating the channel, the local radius of curvature will change, causing the meniscus formed to change shape.

Any of these parameters may be changed alone or in combination. In addition, these parameters may be controlled such that the channel is deformed in at least one step, and then emptied in a subsequent step, e.g. following a chemical reaction.

The non-vertical channel could take any shape, for example a pair of parallel plates or a tube with a circular or polygonal (e.g. triangular) cross section. How far the meniscus extends along the channel can then preferably be controlled by changing the cross-section in at least one dimension, preferably in more than one dimension. This can impact upon one or more relative parameters of the fluid(s), for example the relationship between the local radius of curvature and the curvature of the meniscus. The curvature of the meniscus is defined by the Laplace radius,

$$R = \frac{σ}{Δ p} ,$$

where σ is the surface tension of the fluid and Δp is the change in pressure (the Laplace pressure).

In order to change the cross-section, the channel preferably comprises a flexible material and changing the cross-section of the channel comprises applying a pressure to the channel. This pressure could be mechanical or hydraulic, allowing a flexible channel, for example made from PDMS or PMMA, to change shape under the pressure, altering how far the fluid meniscus extends along the channel.

In an alternative set of embodiments, the channel comprises a piezoelectric material and changing the cross-section of the channel comprises applying an electric field to the channel. This allows the extension of the fluid meniscus to be changed without putting pressure on the channel.

When viewed from a second aspect, the present invention provides a system comprising a non-vertical channel containing a fluid forming a fluid meniscus having a capillary length a and a contact angle θ, the channel in cross-section having a perimeter length |Σ| and an area |Ω|;
the cross-section of the non-vertical channel being selected so as to define a constant Lagrange multiplier λ, where

$$λ = \frac{\vert Σ \vert cos θ}{\vert Ω \vert} ;$$

a functional

$$Φ [ {Γ}^{*} ] ≡ \vert {Γ}^{*} \vert - cos θ \vert {Σ}^{*} \vert + \frac{1}{{a}^{2}} {G}^{*} + λ \vert {Ω}^{*} \vert$$

being minimised to define a minimum value Φ₀=MinΦ, wherein, at a critical transition where Φ₀=0, the fluid defines a smooth arc of length |Γ*| that divides the cross-section of the channel into two parts, |Ω*| is the cross-sectional area of the fluid, which has a curve of length |Σ*| in contact with the channel, and G* represents a vertical position of the centre of mass of the fluid multiplied by the cross-sectional area |Ω*|;
wherein, how far the fluid meniscus extends along the channel is controlled by one or more parameters of the functional Φ[Γ*].

Thus it can be seen that how far the fluid meniscus extends along a non-vertical channel according to the invention can be controlled or tuned according to the required purpose, for example to change the size of the interfacial area available for chemical reactions.

In a set of embodiments, the system may be arranged such that the fluid is selectively emptied from the channel by one or more parameters being controlled so that Φ₀≦0.

In another set of embodiments, the system may be arranged such that the fluid meniscus does not extend outside the channel. In other words, one or more parameters of the functional Φ[Γ*] may be controlled so that fluid is not emptied from the channel.

By controlling one or more parameters of the functional Φ[Γ*], it can be possible to cause draining of a fluid in a channel with a diameter less than the capillary length a of the fluid. This is because other parameters can be changed in order to reduce the value of Φ₀ to below zero, rather than having only one possible variable to cause draining.

The non-vertical channel in which the meniscus is formed may have open or closed ends, depending on the size of the channel. The state of the ends is only relevant to the finite size behaviour of the channel, i.e. when the fluid meniscus extends sufficiently close to an end of the channel that it encounters an end to the channel. For channels in which the fluid meniscus is sufficiently far from the ends, they have no bearing on the behaviour or shape of the meniscus.

Controlling and manipulating fluid e.g. liquid menisci can be used in a wide variety of fields, including but not limited to medical diagnostics or analytical chemistry. These applications may, for example, make use of the extension of the meniscus through changes to one or more absolute or relative fluid parameters, in order to increase the surface area available for reactions. Alternatively, this method may be used to create nano-fluidics devices which are able to be emptied despite having a cross-sectional size substantially smaller than the capillary length a of a fluid. This may be used in the oil and food industries. The above are simply non-limiting examples of potential uses.

Some embodiments of the invention will now be described, by way of example only, with reference to the accompanying drawings in which:

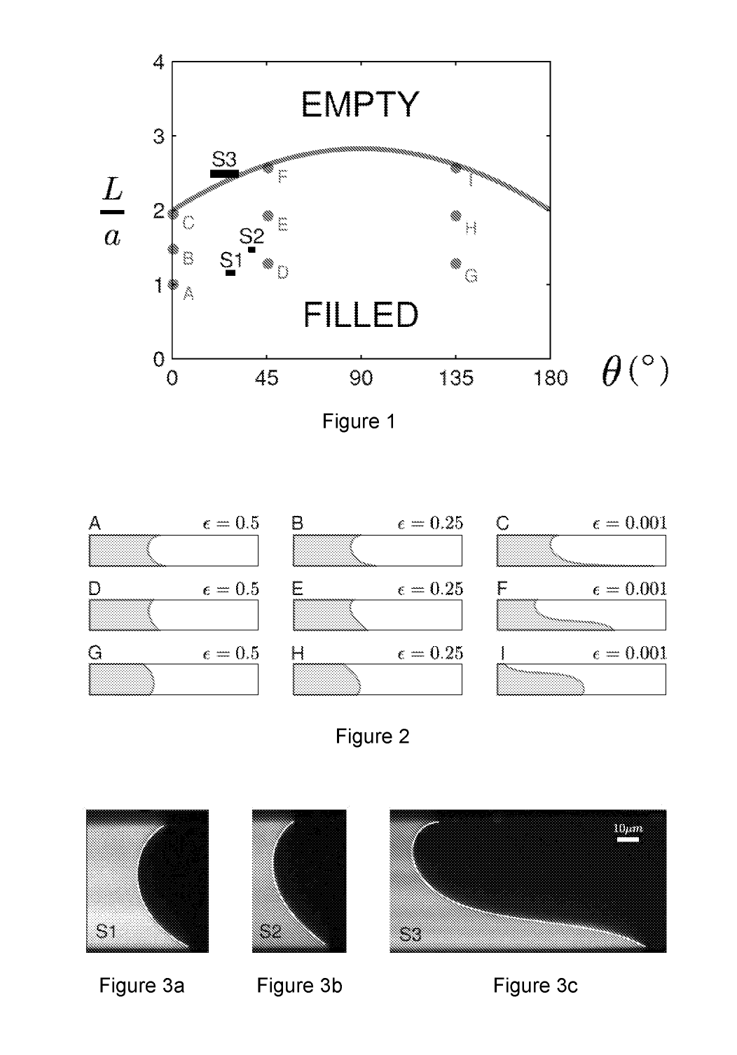

FIG. 1 shows a phase diagram for a fluid meniscus between two parallel plates;

FIG. 2 shows a series of different shaped menisci, with reference to FIG. 1;

FIG. 3 shows three experimental results tied to FIG. 1;

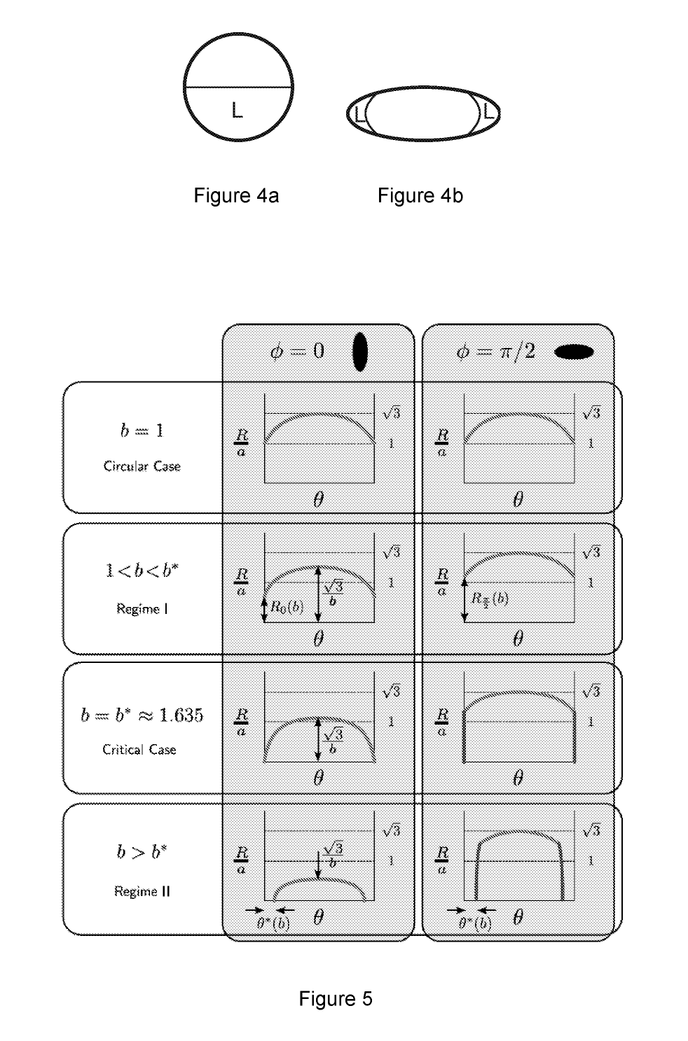

FIG. 4 shows a cross-sectional view of fluid menisci in two exemplary elliptical channels;

FIG. 5 shows a schematic phase diagram for elliptical channels of semi-axes R and bR (b>1) in two different horizontal dispositions;

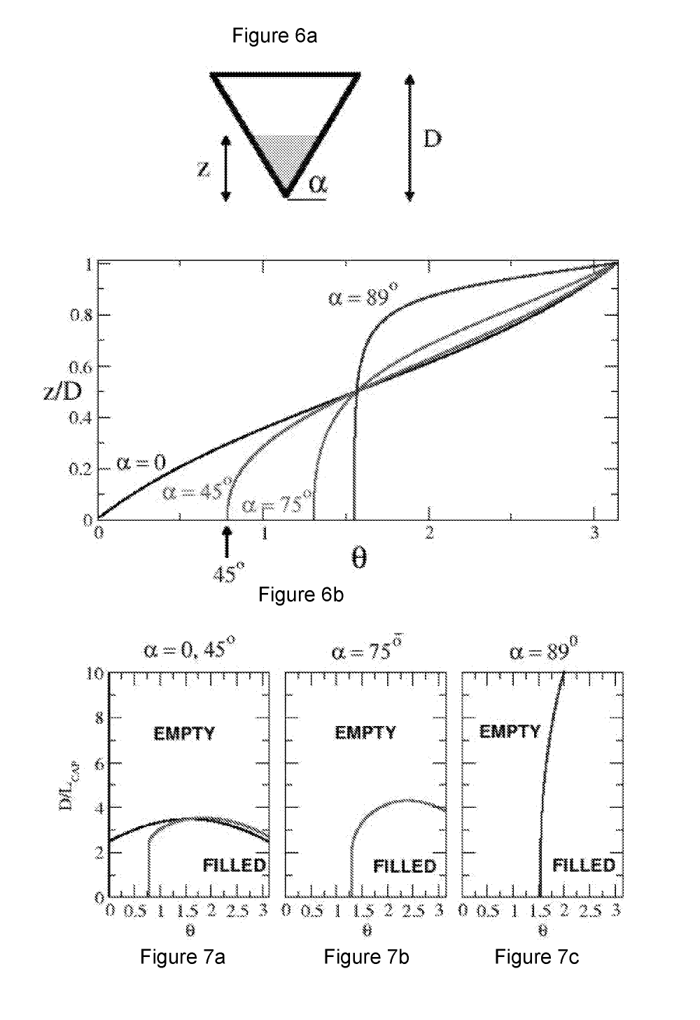

FIG. 6a shows a cross-sectional view of a fluid meniscus in an exemplary triangular channel;

FIG. 6b shows a graph of fluid thickness at emptying over a range of contact angles for the system of FIG. 6a according to an approximate theory;

FIGS. 7a-7c show a series of phase diagrams for the channel of FIG. 6a arranged at different angles to the horizontal according to an approximate theory; and

FIGS. 8a and 8b illustrate the terms used in the controlling function Φ[Γ].

FIG. 1 shows a phase diagram for the stability of menisci within a channel formed between two parallel plates. The relationship between contact angle (θ) and the ratio (L/a) of plate separation L to capillary length a is shown, with the curve marking the critical position at which the meniscus changes between being bound and unbound, i.e. where Φ[Γ]=0. At this critical point, the meniscus has the largest exposed surface area as can be seen in FIGS. 2 and 3, where points C, F and I are slightly offset from the critical point. At any points above the critical line, the fluid is unbound and will drain from the channel, whereas below the critical line, the fluid will remain bound in the channel, with a meniscus that varies in extension depending on the position of the system in the phase diagram.

FIG. 2. shows a series of cross-sectional views through the channel, which correspond to the points shown in FIG. 1. FIGS. 2A, 2D and 2G are all at the same relative distance from the critical curve Φ₀[Γ*]=0, with

$$ɛ = \frac{{L}_{E} - L}{{L}_{E}} = 0.5$$

where L_{E} is the distance between the plates at which the channel will empty. This means that they track the curve with changing contact angle, rather than having a set plate distance L. FIGS. 2B, 2E and 2H all have ε=0.25, and FIGS. 2C, 2F and 2I have ε=0.001. As can be seen, the smaller the value of ε, the longer the meniscus. In addition, a larger contact angle means that the meniscus is more highly affected by gravity. FIGS. 2A to 2I demonstrate theoretical results, whereas FIGS. 3A to 3C demonstrate experimental results, in which colloid-rich and polymer-rich solutions of PMMA colloids and non-adsorbing polystyrene polymer in decalin are used to show the deformation of the meniscus under different operating circumstances. In the cases such as FIGS. 2C, 2F, 2I and 3C, the meniscus can be made to span a very large distance without crossing the phase boundary, such that the extension of the meniscus is reversible.

While control over a meniscus formed can be carried out through changes in the capillary length as can be seen in FIGS. 1 to 3, this is not the only influential parameter. There is also a dependence on contact angle θ (and on cross-sectional shape) which can be used to alternatively or further control the behaviour of the meniscus.

FIGS. 4A and 4B schematically demonstrate the difference in meniscus shape for different shaped channels. In a circular channel as in FIG. 4A (with θ=90°), the meniscus sits across the centre of the height of the channel, with all of the liquid in the lower half. However, when an ellipsoidal channel is used (as in FIG. 4B), the meniscus extends along the points of maximum curvature of the capillary (i.e. the sides), or along the bottom, depending on the parameters. This is because the liquid will pool in regions of high curvature. As the sides of the channel have a much higher radius of curvature than the top and bottom, the liquid forms tongues over these regions, as here the relationship between the local radius of curvature and the Laplace radius R is such that the liquid is able to form a tongue, and does not immediately drain from the channel. It is these regions of high curvature which are the first to drain as fluid parameters are changed to induce drainage.

FIG. 5 shows a series of schematic phase diagrams for elliptical channels, in which the eccentricity and orientation of the ellipse are varied. As can be seen, for an eccentricity larger than a critical value, there is a range of contact angles 0≦θ<θ*(b) for which the meniscus is unbound for any size of capillary and, hence, the channel cannot hold any fluid down to microscopic sizes.

FIG. 6a shows a channel with a triangular cross-section of height D. A liquid tongue of height z has formed in the lowest vertex, where the triangle is held at an angle α to the horizontal. It is assumed that the liquid tongue is perfectly flat and horizontal, which is an accurate approximation whenever the contact angle θ≈α. However, for θ≈π, this will not be true, and it is expected that there will be features not seen in these figures.

FIG. 6b shows how the thickness of the tongue (z) varies with contact angle (θ) for a number of different values of α according to the above approximation. The initial thickness varies according to α, as at α=0°, the lower side of the channel is much wider than at α=89°, as it is a side of the triangle rather than the vertex. However, for all of the values of a shown, as θ increases, the thickness z increases.

FIGS. 7a to 7c show phase diagrams for triangular channels at a range of values of α as shown in FIG. 6b, according to the above approximation. For α=0°, the channel can only be emptied by increasing the ratio of height D to capillary length, and will always be filled for D/L_{C} under around 4. However, as α is increased, it becomes possible to empty the capillary at low contact angles for any ratio of D/L_{C}, meaning that micro- and nanoscopic channels can be emptied. At the other extreme, where α=89°, for high contact angles (i.e. θ≧π/2) the channel will remain filled, even for relatively large channels (D/L_{C}>>10). At this extreme (α=89°), for θ<π/2 the channel will not be able to hold fluid, even at microscopic sizes.

FIGS. 8a and 8b illustrate the terms used in the controlling function Φ[Γ*]. In FIG. 8a, a channel without any fluid is shown, in which Ω demonstrates the cross-sectional area and Σ shows the perimeter of the channel (without any fluid). In FIG. 8b, a channel containing a fluid is shown, where the fluid has formed a tongue in a region of high curvature dividing the channel into two parts. The tongue therefore has the following parameters when Φ₀=0:|Γ*| which is the arc length of the tongue spanning the cross-section of the channel; |Ω*| which is the cross-sectional area of the tongue; and |Σ*| which is the perimeter length of the tongue in contact with the channel.

1. A method of controlling a fluid meniscus in a non-vertical channel, comprising:
containing a fluid in a non-vertical channel so as to form a fluid meniscus having a capillary length a and a contact angle θ, the non-vertical channel in cross-section having a perimeter length |Σ| and an area |Ω|;
selecting the cross-section of the non-vertical channel so as to define a constant Lagrange multiplier λ, where
$$λ = \frac{\vert Σ \vert cos θ}{\vert Ω \vert} ;$$
minimising a functional
$$Φ [ {Γ}^{*} ] ≡ \vert {Γ}^{*} \vert - cos θ \vert {Σ}^{*} \vert + \frac{1}{{a}^{2}} {G}^{*} + λ \vert {Ω}^{*} \vert$$
to define a minimum value Φ₀=MinΦ, wherein, at a critical transition where Φ₀=0, the fluid defines a smooth arc of length |Γ*| that divides the cross-section of the non-vertical channel into two parts, |Ω*| is a cross-sectional area of the fluid, which has a curve of length |Σ*| in contact with the non-vertical channel, and G* represents a vertical position of a centre of mass of the fluid multiplied by the cross-sectional area |Ω*|; and
controlling how far the fluid meniscus extends along the non-vertical channel by selecting one or more parameters of the functional Φ|Γ*|.

2. The method of claim 1, comprising selectively emptying the fluid from the non-vertical channel by controlling one or more parameters so that Φ₀≦0.

3. The method of claim 1, comprising controlling how far the fluid meniscus extends along the non-vertical channel without emptying.

4. The method of claim 1, wherein selecting the cross-section of the non-vertical channel comprises varying a size, shape and/or orientation of the non-vertical channel.

5. The method of claim 1, wherein controlling how far the fluid meniscus extends along the non-vertical channel comprises changing the contact angle θ.

6. The method of claim 5, wherein changing the contact angle θ comprises adjusting a material parameter of the fluid.

7. The method of claim 5, wherein changing the contact angle θ comprises adjusting a material parameter of the non-vertical channel.

8. The method of claim 7, wherein changing the contact angle θ comprises modifying wetting properties of at least a region of a surface of the non-vertical channel.

9. The method of claim 1, wherein controlling how far the fluid meniscus extends along the non-vertical channel comprises changing the capillary length a by altering the fluid.

10. The method of claim 9, wherein changing the capillary length a comprises adjusting a temperature of the fluid.

11. The method of claim 9, wherein changing the capillary length a comprises adjusting a density of the fluid.

12. The method of claim 9, wherein changing the capillary length a comprises adjusting a composition of the fluid.

13. The method of claim 1, wherein controlling how far the fluid meniscus extends along the non-vertical channel comprises changing gravitational acceleration.

14. The method of claim 1, wherein selecting the cross-section of the non-vertical channel comprises changing a rotational orientation of the non-vertical channel in a horizontal plane.

15. The method of claim 1, wherein selecting the cross-section of the non-vertical channel comprises changing a shape of the cross-section in at least one dimension.

16. The method of claim 1, wherein the non-vertical channel comprises a flexible material and selecting the cross-section of the non-vertical channel comprises applying a pressure to the non-vertical channel.

17. The method of claim 1, wherein the non-vertical channel comprises a piezoelectric material and selecting the cross-section of the non-vertical channel comprises applying an electric field to the non-vertical channel.

18. A system comprising a non-vertical channel containing a fluid forming a fluid meniscus having a capillary length a and a contact angle θ, the non-vertical channel in cross-section having a perimeter length |Σ| and an area |Ω|;
the cross-section of the non-vertical channel being selected so as to define a constant Lagrange multiplier λ, where
$$λ = \frac{\vert Σ \vert cos θ}{\vert Ω \vert} ;$$
a functional
$$Φ [ {Γ}^{*} ] ≡ \vert {Γ}^{*} \vert - cos θ \vert {Σ}^{*} \vert + \frac{1}{{a}^{2}} {G}^{*} + λ \vert {Ω}^{*} \vert$$
being minimised to define a minimum value Φ₀=MinΦ, wherein, at a critical transition where Φ₀=0, the fluid defines a smooth arc of length |Γ*| that divides the cross-section of the non-vertical channel into two parts, |Ω*| is a cross-sectional area of the fluid, which has a curve of length |Σ*| in contact with the non-vertical channel, and G* represents a vertical position of a centre of mass of the fluid multiplied by the cross-sectional area |Ω*|;
wherein, how far the fluid meniscus extends along the non-vertical channel is controlled by one or more parameters of the functional Φ|Γ*|.

19-34. (canceled)
